(19) United States
(12) Patent Application Publication
(10) Pub. No.: US 2026/0210509 A1
(43) Pub. Date: Jul. 23, 2026

(54) VEHICLE LAMP

(71) Applicants: SL Corporation, Daegu (KR); Etendue Lighting Co., Ltd., Bucheon-si (KR)

(72) Inventors: Jun Yeong PARK, Gyeongsan-si, Gyeongsangbuk-do (KR); Jin Young JUNG, Gyeongsan-si, Gyeongsangbuk-do (KR); So Young LEE, Bucheon-si, Gyeonggi-do (KR); Sun Gu KANG, Bucheon-si, Gyeonggi-do (KR)

(21) Appl. No.: 19/367,552

(22) Filed: Oct. 23, 2025

Related U.S. Application Data
(63) Continuation of application No. PCT/KR2024/006969, filed on May 23, 2024.

(30) Foreign Application Priority Data
May 30, 2023 (KR) 10-2023-0069025

(51) Int. Cl. F21S 41/24

(52) U.S. Cl. CPC F21S 41/24

(57) ABSTRACT

A vehicle lamp forms a beam pattern by at least one lamp module. The at least one lamp module includes a light source that generates light; and a light guide that guides the light incident from the light source to be emitted. The light guide includes a light-receiving portion on which the light is incident from the light source unit; a light-emitting portion that emits the light incident on the light-receiving portion; and a light-transfer portion that is connected between the light-receiving portion and the light-emitting portion to transmit at least a part of the light incident on the light-receiving portion to the light-emitting portion. The light-receiving portion has an upper portion and a lower portion formed asymmetrically with each other with respect to a reference line that coincides with an optical axis of the light source.

### CROSS-REFERENCE TO RELATED APPLICATIONS

This application is a Continuation of International Application No. PCT/KR 2024/006969 filed May 23, 2024, which claims priority from Korean Application No. 10-2023-0069025 filed May 30, 2023. The aforementioned applications are incorporated herein by reference in their entireties.

### TECHNICAL FIELD

The present disclosure relates to a lamp for a vehicle, and more particularly, to a lamp for a vehicle capable of improving light efficiency when forming a beam pattern.

### RELATED ART

In general, a vehicle is provided with various lamps having an illumination function for more easily identifying an object located around the vehicle during low-light conditions (e.g., night-time driving) and a signaling function for notifying other vehicles or road users of a driving state of the vehicle.

For example, a headlamp and a fog lamp are mainly used for the illumination function, and a turn signal lamp, a tail lamp, and a brake lamp are mainly used for the signaling function. Each lamp is stipulated under regulations in terms of an installation standard and specifications thereof so that each lamp can fully perform each function.

The head lamp plays a very important role in ensuring safe driving by irradiating light in a driving direction of the vehicle to secure a front field of view of a driver. The head lamp allows a low beam pattern and a high beam pattern to be formed. In the low beam pattern, light is irradiated under a cut-off line to prevent glare from occurring to a driver of a front vehicle, thereby securing a wider field of view within a short distance in front of the vehicle, while in the high beam pattern, light is irradiated above the cut-off line to allow for a longer field of view in front of the vehicle to be secured.

In this regard, in the low beam pattern, a portion of the light generated from the light source is blocked to form the cut-off line, and consequently, light loss may occur and light efficiency may be deteriorated. Thus, a scheme of forming an optimal beam pattern while reducing light loss is required.

### SUMMARY

A purpose to be achieved by the present disclosure is to provide a lamp for a vehicle capable of reducing light loss by allowing light generated from a light source to be emitted without loss.

The purposes of the present disclosure are not limited to the above-mentioned purposes, and other purposes not mentioned will be clearly understood by those skilled in the art from the following description.

In order to achieve the above purpose, a lamp for a vehicle according to an embodiment of the present disclosure may include at least one lamp module forming a beam pattern. The at least one lamp module may include a light source that generates light; and a light guide that guides the light incident thereon from the light source to be emitted. The light guide may include a light-receiving portion that receives the light from the light source; a light-emitting portion through which the light incident thereon from the light-receiving portion is emitted; and a light-transfer portion that is connected to and disposed between the light-receiving portion and the light-emitting portion and transmits at least a portion of the light incident thereon from the light-receiving portion to the light-emitting portion. The light-receiving portion may have upper and lower portions formed asymmetrically with each other with respect to a reference line, which coincides with an optical axis of the light source.

The light-receiving portion may include: a central surface having a central point disposed on the optical axis of the light source; a protruding surface formed to protrude from an edge of the central surface toward the light source; and a reflective surface that reflects the light incident on the protruding surface so as to cause it to proceed in a forward direction. Upper and lower regions of at least one of the center surface, the protruding surface, or the reflective surface may be formed asymmetrically with each other with respect to the reference line.

The light-receiving portion may include: a first light-receiving module that is disposed above the reference line and focuses the light incident thereon from the light source on a first focus; and a second light-receiving module that is disposed below the reference line and causes the light incident thereon from the light source to proceed toward a second focus.

The first focus may correspond to a rear focus of the light-emitting portion. The second focus may be disposed above the first focus. The first focus may be formed inside the light guide, and the second focus may be formed outside the light guide and above an upper side of the light guide.

The first light-receiving module and the second light-receiving module may have different curvatures in at least one of a vertical direction or a left-right direction. A vertical curvature of the first light-receiving module may be smaller than a vertical curvature of the second light-receiving module, and a lateral curvature of the first light-receiving module may be greater than a lateral curvature of the second light-receiving module.

The first light-receiving module and the second light-receiving module may have different dimensions in at least one of a vertical direction or a left-right direction. A vertical height of the first light-receiving module may be greater than a vertical height of the second light-receiving module, and a lateral width of the first light-receiving module may be smaller than a lateral width of the second light-receiving module.

The light-transfer portion may include: a shield portion constituting a portion of a lower surface of the light guide, the shield portion having a front end disposed at or near a first focus, which corresponds to a rear focus of the light-emitting portion; and a reflective portion that constitutes a portion of an upper surface of the light guide and reflects a portion of the light incident thereon from the light-receiving portion so as to cause it to be focused on the first focus.

The reflective portion may reflect the light incident through a lower portion of the light-receiving portion and proceeding toward a second focus, which is disposed above the first focus, so as to cause it to be focused onto the first focus. The second focus and the first focus may be mirror images with each other with respect to the reflective portion.

The light guide may include an optical pattern formed between the reflective portion and the emitting portion, and the optical pattern may prevent the light incident onto the light-receiving portion from transmitting through an area between the reflection portion and the light-emitting portion and proceeding upwardly of the light guide to exterior.

The light-emitting portion may have a convex or concave shape in a forward direction.

The light-emitting portion may include a plurality of facets, and at least one of a formation angle, a curvature, or a size of one of the plurality of facets may be different from the formation angle, the curvature, or the size of at least another of the plurality of facets.

The light guide may include a reinforcement portion formed in at least one of an upper surface or a lower surface of the light guide to reinforce structural rigidity.

Other specific features of the present disclosure are included in the detailed description and drawings.

According to the lamp for a vehicle of the present disclosure as described above, one or more of the following effects can be achieved.

The light incident from the light source to the upper portion of the light-receiving portion may be focused on the rear focus of the light-emitting portion. The light incident from the light source to the lower portion of the light-receiving portion and proceeding so as to be focused on a point located above the rear focus of the light-emitting portion may be reflected from the reflective portion so as to be focused on the rear focus of the light-emitting portion. Thus, a portion of the light that proceeds from the light-receiving portion toward the light-emitting portion in order to form the cut-off line may be prevented from being lost, thereby improving light efficiency.

The effects of the present disclosure are not limited to those mentioned above, and other effects not mentioned will be clearly understood by those skilled in the art from the description of the claims.

### BRIEF DESCRIPTION OF THE DRAWINGS

FIG. 1 is a perspective view illustrating a lamp for a vehicle according to an embodiment of the present disclosure.

FIG. 2 is a plan view illustrating a lamp for a vehicle according to an embodiment of the present disclosure.

FIGS. 3 to 5 are perspective views showing a lamp module according to an embodiment of the present disclosure.

FIG. 6 is a plan view showing a lamp module according to an embodiment of the present disclosure.

FIG. 7 is a cross-sectional view taken along line A-A′ of FIG. 3.

FIG. 8 is a rear view showing a light-receiving portion of a light guide according to an embodiment of the present disclosure.

FIG. 9 is a side view illustrating a light-receiving portion of a light guide according to an embodiment of the present disclosure.

FIG. 10 is a plan view illustrating a light-receiving portion of a light guide according to an embodiment of the present disclosure.

FIG. 11 is a schematic view showing a beam pattern formed by a lamp module according to an embodiment of the present disclosure.

FIG. 12 is a schematic diagram showing a light path of a lamp module according to an embodiment of the present disclosure.

FIG. 13 is a schematic diagram showing a brightness distribution of a beam pattern formed by a lamp module according to an embodiment of the present disclosure.

FIG. 14 is an enlarged schematic view of a second area of FIG. 13.

FIG. 15 is a schematic diagram illustrating a light path by an optical pattern according to an embodiment of the present disclosure.

FIG. 16 is a perspective view illustrating a lamp module according to another embodiment of the present disclosure.

FIGS. 17 and 18 are perspective views illustrating a lamp for a vehicle according to another embodiment of the present disclosure.

### DETAILED DESCRIPTION

The advantages and features of the present disclosure and a method of achieving them will become apparent with reference to the embodiments described in detail below together with the accompanying drawings. However, the present disclosure is not limited to the embodiments disclosed below, but may be implemented in various different forms, and the present embodiments are provided to make the disclosure of the present disclosure complete and to fully inform those skilled in the art to which the present disclosure belongs of the scope of the disclosure, and the present disclosure is only defined by the scope of the claims. The same reference numerals refer to the same components throughout the present disclosure.

Thus, in some embodiments, well-known process steps, well-known structures, and well-known techniques are not specifically described to prevent the present disclosure from being interpreted vaguely.

The terms used herein are intended to describe the embodiments and are not intended to limit the present disclosure. In the present specification, the singular constitutes “a” and “an” are intended to include the plural constitutes as well, unless the context clearly indicates otherwise. As used herein, the term “comprises” and/or “comprising” are used in the sense that the presence or addition of one or more other components, steps, operations, and/or elements other than the mentioned components, steps, operations, and/or elements is not excluded. Further, “and/or” includes each of the mentioned items and all combinations of one or more thereof.

Further, the embodiments described herein will be described with reference to cross-sectional views and/or schematic diagrams, which are exemplary diagrams of the present disclosure. Accordingly, the form of the example diagram may be modified due to a manufacturing technique and/or tolerances. Accordingly, the embodiments of the present disclosure are not limited to the specific form as shown, but also include a change in a form as generated according to the manufacturing process. In addition, in each drawing illustrated in the present disclosure, each component may be slightly enlarged or reduced in consideration of convenience of illustration. The same reference numerals refer to the same components throughout the present disclosure.

Hereinafter, the present disclosure will be described with reference to drawings for illustrating a lamp for a vehicle according to embodiments of the present disclosure.

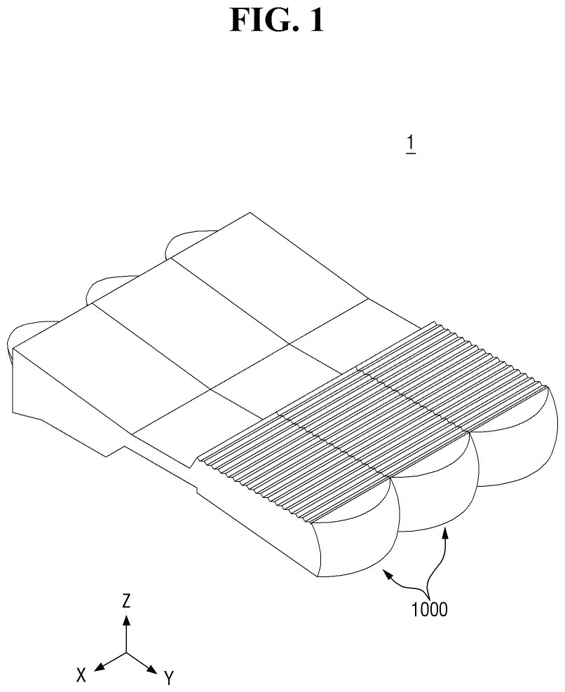

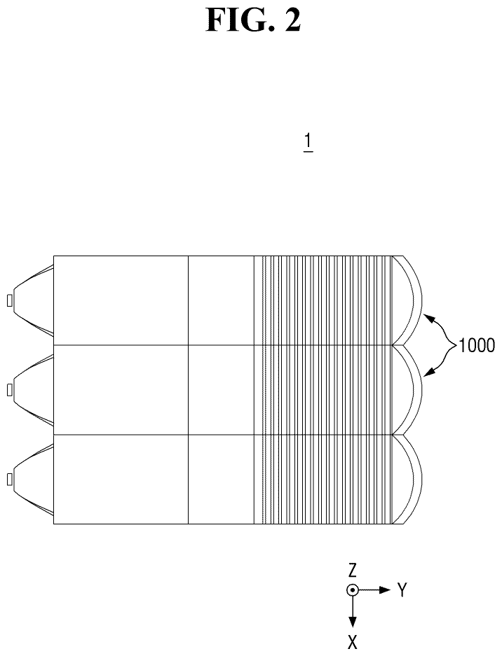

FIG. 1 is a perspective view illustrating a lamp for a vehicle according to an embodiment of the present disclosure, and FIG. 2 is a plan view illustrating a lamp for a vehicle according to an embodiment of the present disclosure.

Referring to FIGS. 1 and 2, a lamp 1 for a vehicle according to an embodiment of the present disclosure may include a plurality of lamp modules 1000 arranged in at least one direction.

In an embodiment of the present disclosure, a case in which the vehicle lamp 1 is used as a head lamp for securing a front view of the vehicle during low-light conditions (e.g., night-time driving) is described by way of example. However, the present disclosure is not limited thereto, and the vehicle lamp 1 according to the present disclosure may be used as various lamps installed in the vehicle, such as a tail lamp, a brake lamp, a daytime running lamp, a turn signal lamp, a fog lamp, a backup lamp, a position lamp, and the like, as well as the head lamp.

When the lamp 1 for a vehicle according to the present disclosure is used as the head lamp, a low beam pattern for securing a wider field of view within a relatively short distance in front of the vehicle may be formed by irradiating light to below a cut-off line so that glare does not occur toward a driver of a vehicle in front of the present vehicle having the lamp 1, such as a preceding vehicle or an opposing vehicle, or a high beam pattern for securing a longer field of view in front of the vehicle may be formed by irradiating light above the cut-off line. Hereinafter, in an embodiment of the present disclosure, a case in which the low beam pattern is formed by the lamp 1 for a vehicle will be described by way of example.

In this regard, in an embodiment of the present disclosure, a case in which the lamp 1 for a vehicle includes the plurality of lamp modules 1000 arranged in the left-right direction will be described by way of example. However, this configuration is merely an example for helping understanding of the present disclosure, and the number or arrangement direction of the lamp modules included in the lamp 1 for a vehicle of the present disclosure may be variously changed according to the light distribution characteristics of the beam pattern to be formed by the lamp 1 for a vehicle of the present disclosure, that is, the brightness, position, size, shape, and the like of an area to which the light is irradiated.

Hereinafter, in an embodiment of the present disclosure, one lamp module among the plurality of lamp modules 1000 will be described by way of example. This description may be similarly applied to each of the remaining lamp modules with only a difference in an installation position. A case in which an X-axis direction represents a vehicle width direction (e.g., lateral direction) as the left-right direction, an Y-axis direction represents a driving direction (e.g., longitudinal direction) as the front-rear direction, and a Z-axis direction represents a vehicle height direction as a vertical direction will be described by way of example.

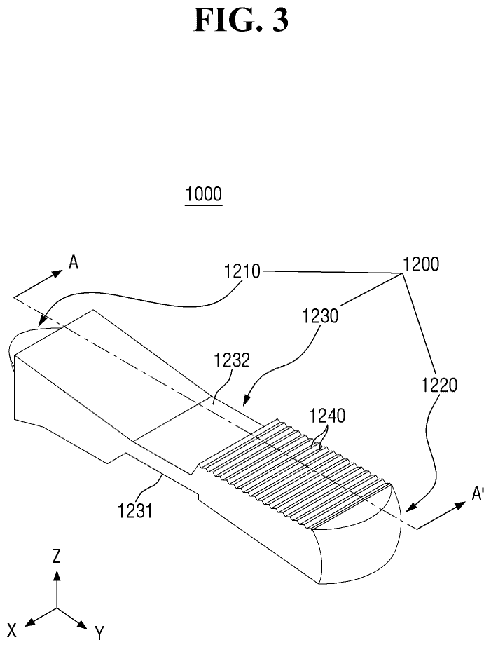

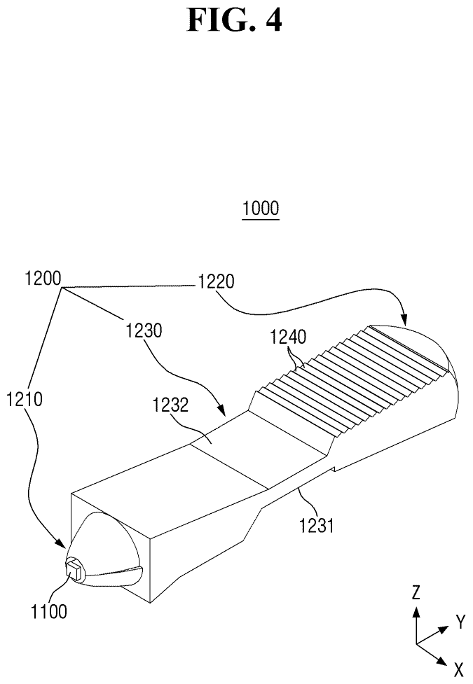

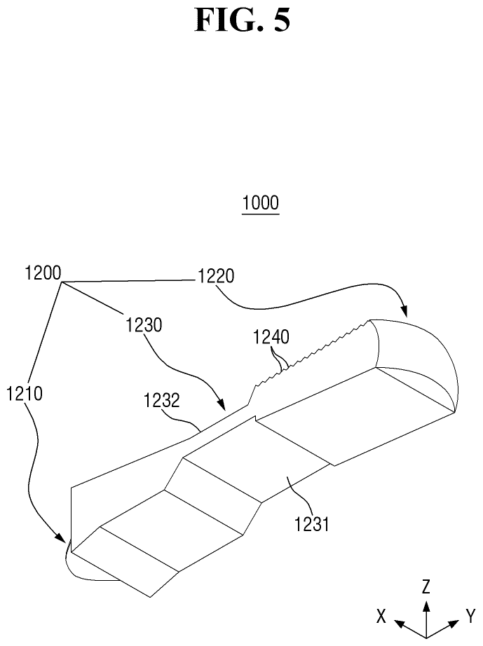

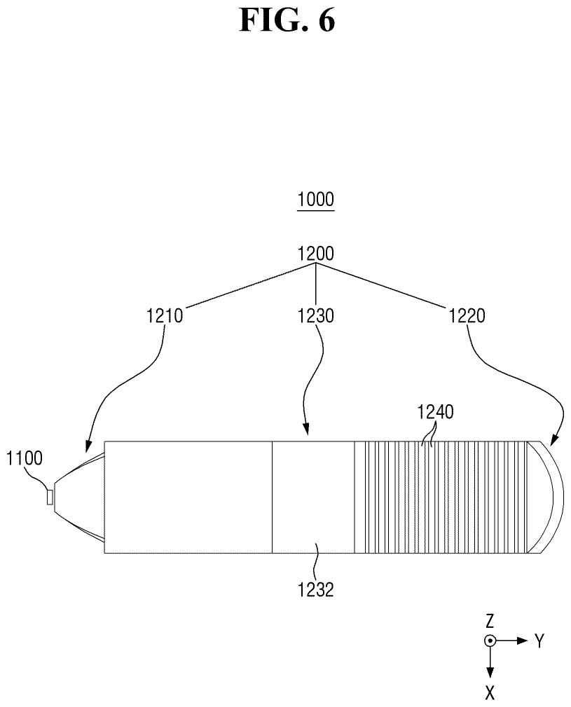

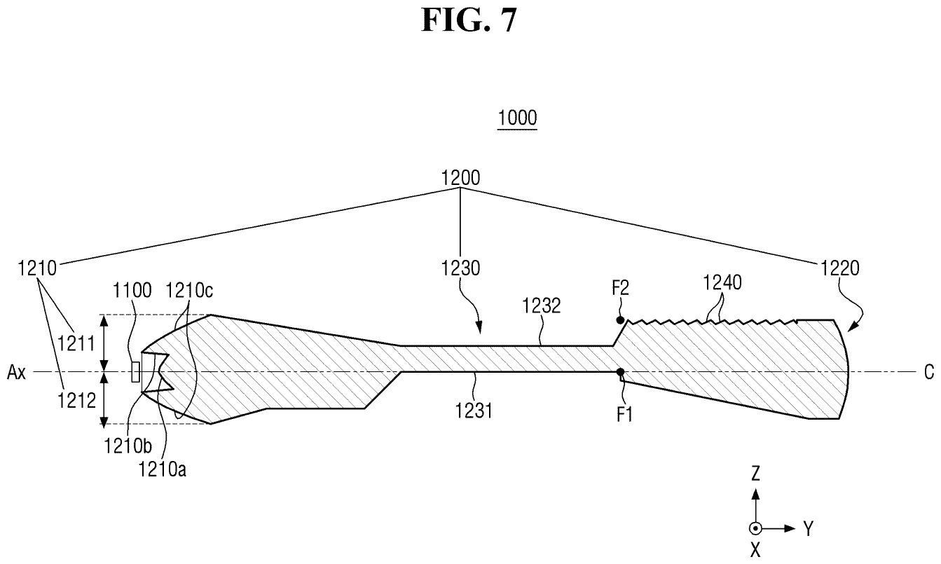

FIGS. 3 to 5 are perspective views illustrating a lamp module according to an embodiment of the present disclosure, FIG. 6 is a plan view illustrating the lamp module according to an embodiment of the present disclosure, and FIG. 7 is a cross-sectional view taken along line A-A′ of FIG. 3.

Referring to FIGS. 3 to 7, the lamp module 1000 according to an embodiment of the present disclosure may include a light source 1100 and a light guide 1200. The light source 1100 may include at least one light source that generates light having a light amount and/or color suitable for the use of the lamp 1 for a vehicle of the present disclosure.

In an embodiment of the present disclosure, a case in which a semiconductor light-emitting device such as a light-emitting diode (LED) is used as at least one light source is described by way of example. However, the present disclosure is not limited thereto, and various types of light sources such as a laser diode (LD) or a bulb as well as the LED may be used as at least one light source, and optical elements such as a reflector, a phosphor, a mirror, a prism, and the like may be additionally used depending on the type of the light source.

The light guide 1200 may be disposed in front of the light source 1100 to guide the light incident thereto from the light source 1100 to be emitted in the forward direction. To this end, the light source 1100 may be disposed such that a light-emitting surface or a light-emitting area faces the forward direction.

In this regard, the light guide 1200 being disposed in front of the light source 1100 may indicate the relative positions of the light source 1100 and the light guide 1200 when it is assumed that the direction in which the light is irradiated from the vehicle lamp 1 of the present disclosure is the forward direction. However, the actual direction indicated by the forward direction may vary depending on the position at and/or the orientation in which the vehicle lamp 1 of the present disclosure is installed.

The light guide 1200 may include a light-receiving portion 1210, a light-emitting portion 1220, and a light-transfer portion 1230. The light-receiving portion 1210 may serve to allow different portions of the light incident thereof from the light source 1100 to be focused on different focal points. To this end, the light-receiving portion 1210 may be formed such that the different portions have different curvatures.

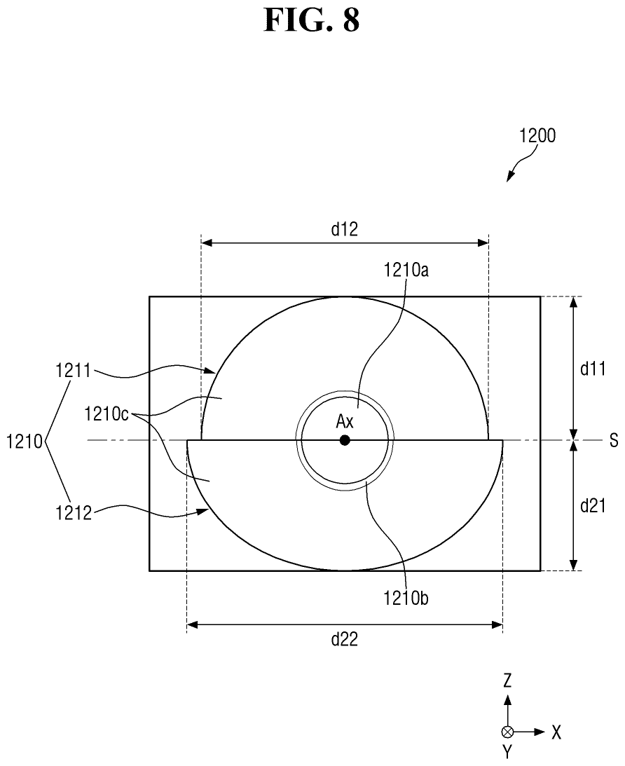

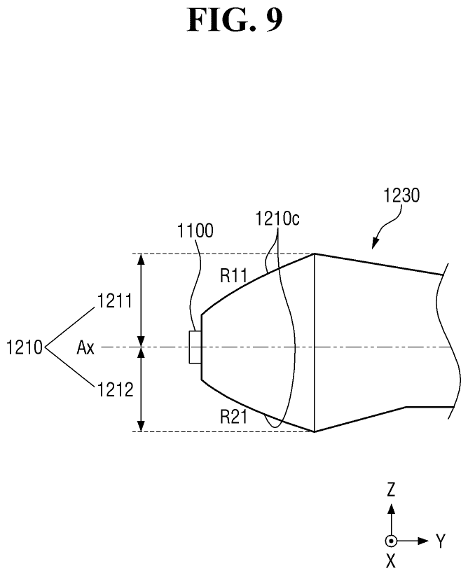

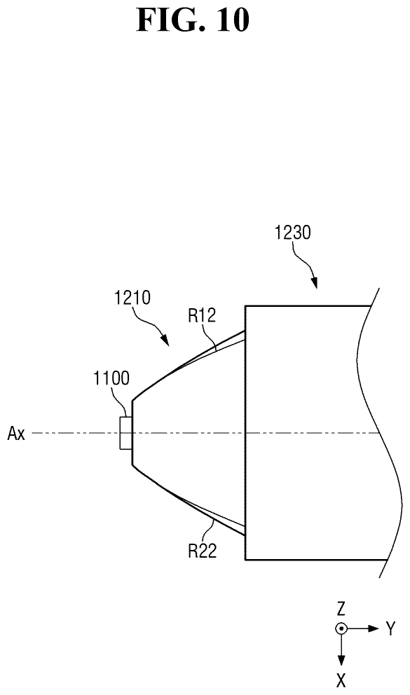

FIG. 8 is a rear view illustrating a light-receiving portion of a light guide according to an embodiment of the present disclosure, FIG. 9 is a side view illustrating a light-receiving portion of a light guide according to an embodiment of the present disclosure, and FIG. 10 is a plan view illustrating a light-receiving portion of a light guide according to an embodiment of the present disclosure.

Referring to FIGS. 8 to 10, the light-receiving portion 1210 according to an embodiment of the present disclosure may be formed such that an upper portion and a lower portion with respect to a reference line S, which coincides with an optical axis Ax of the light source 1100, are formed asymmetrically with each other.

In this regard, the optical axis Ax of the light source 1100 may refer to an imaginary line that perpendicularly passes through the light-emitting surface of the light source. When the light source 1100 includes a plurality of light sources, the optical axis Ax may be understood as an imaginary line that passes, in a perpendicular manner, through a center of the light-emitting area by which the light is collectively generated from the light source 1100.

The light-receiving portion 1210 may include a first light-receiving module 1211 disposed above the reference line S and a second light-receiving module 1212 disposed below the reference line S. The light-receiving portion 1210 being asymmetrically formed with respect to the reference line S may be understood that the first light-receiving module 1211 and the second light-receiving module 1212 are asymmetrically formed with respect to each other.

The light-receiving portion 1210 may include a central surface 1210a, a protruding surface 1210b that protrudes from an edge of the central surface 1210a toward the light source 1100, and a reflective surface 1210c that reflects the light incident on the protruding surface 1210b therefrom so as to proceed in the forward direction.

In this regard, the first light-receiving module 1211 may include the upper portion of each of the central surface 1210a, the protruding surface 1210b, and the reflective surface 1210c, which are disposed above the reference line S. The second light-receiving module 1212 may include the lower portion of each of the central surface 1210a, the protruding surface 1210b, and the reflective surface 1210c, which are disposed under the reference line S.

The asymmetrical formation of the first light-receiving module 1211 and the second light-receiving module 1212 may include a case in which the first light-receiving module 1211 and the second light-receiving module 1212 have different lengths (e.g., dimensions) in at least one of the vertical direction or the left-right direction and a case in which they have different curvatures in at least one of the vertical direction or the left-right direction.

The first light-receiving module 1211 and the second light-receiving module 1212 having the different lengths may include a case in which an area in which an upper portion of at least one of the central surface 1210a, the protruding surface 1210b, or the reflective surface 1210c disposed above the reference line S and a lower portion of at least one of the central surface 1210a, the protruding surface 1210b, or the reflective surface 1210c disposed below the reference line S have the different lengths in at least one direction.

In addition, the first light-receiving module 1211 and the second light-receiving module 1212 having different curvatures may include a case in which an upper portion of at least one of the central surface 1210a, the protruding surface 1210b, or the reflective surface 1210c disposed above the reference line S and a lower portion of at least one of the central surface 1210a, the protruding surface 1210b, or the reflective surface 1210c disposed below the reference line S have the different curvatures in at least one direction.

In an embodiment of the present disclosure, the first light-receiving module 1211 may have a curvature R11 that is smaller than a curvature R21 of the second light-receiving module 1212 in the vertical direction. This configuration may allow the light incident on the first light-receiving module 1211 to be focused on a rear focus F1 (hereinafter referred to as a “first focus”) behind the light light-emitting portion 1220 and may allow the light incident on the second light-receiving module 1212 to be focused on a second focus F2 that is disposed above the first focus F1.

In an embodiment of the present disclosure, the focus may be formed as a point, a line, a surface, a space, or any combinations thereof depending on the area onto which the light is actually concentrated.

In this regard, the light incident to the second light-receiving module 1212 may be focused on the second focus F2 disposed above the first focus F1 so that the light can travel to the light-emitting portion 1220 without interference with a shield portion 1231 to be described later, thereby reducing light loss and improving light efficiency, and a detailed description thereof will be described later.

In addition, in an embodiment of the present disclosure, the first light-receiving module 1211 may have a curvature R12 that is greater than a curvature R22 of the second light-receiving module 1212 in the left-right direction. This configuration may enable a beam pattern formed by the lamp 1 for a vehicle of the present disclosure to satisfy required light distribution characteristics, and a detailed description thereof will be described later.

As described above, as the vertical curvature R11 of the first light-receiving module 1211 is smaller than the vertical curvature R21 of the second light-receiving module 1212, and the lateral curvature R12 of the first light-receiving module 1211 is greater than the lateral curvature R22 of the second light-receiving module 1212, the first light-receiving module 1211 may exhibit a length d11 that is greater than a length d21 of the second light-receiving module 1212 in the vertical direction (e.g., height) and may exhibit a length d12 that is smaller than a length d22 of the second light-receiving module 1212 in the left-right direction (e.g., width).

In an embodiment of the present disclosure, a case in which the height and the width of each of the first light-receiving module 1211 and the second light-receiving module 1212 are determined based on the curvatures of each of the first light-receiving module 1211 and the second light-receiving module 1212 will be described by way of example to help understand the present disclosure. However, the present disclosure is not limited thereto. Even when the first light-receiving module 1211 has a smaller vertical curvature than that of the second light-receiving module 1212, the first light-receiving module 1211 may have a smaller height than that of the second light-receiving module 1212. Even when the first light-receiving module 1211 has a larger lateral curvature than that of the second light-receiving module 12, the first light-receiving module 1211 may have a larger width than that of the second light-receiving module 1212.

For example, when at least one of the central surface 1210a, the protruding surface 1210b, or the reflective surface 1210c is formed such that a step is formed between the upper and lower portions thereof with respect to the reference line S, the widths and the heights of each of the first light-receiving module 1211 and the second light-receiving module 1212 may not be dependent on the curvatures of the first light-receiving module 1211 and the second light-receiving module 1212.

The light-emitting portion 1220 may be disposed in front of the light light-receiving portion 1210 to emit the light incident thereon from the light light-receiving portion 1210 in the forward direction. The light-emitting portion 1220 may be formed to have a convex shape in the forward direction for condensing the emitted light. A central axis C of the light-emitting portion 1220 at which the first focus F1 is disposed may be formed to coincide with the optical axis Ax of the light source portion 1100.

In an embodiment of the present disclosure, a case in which the light-emitting portion 1220 has the convex shape in the forward direction is described by way of example. However, this is only an example for helping understanding of the present disclosure, and the present disclosure is not limited thereto. In order that a beam pattern having a spreading characteristic is formed, the light-emitting portion 1220 may have a concave shape in the forward direction.

The light-transfer portion 1230 may be formed to be connected to and disposed between the light-receiving portion 1210 and the light-emitting portion 1220 to allow at least a portion of the light incident thereto from the light-receiving portion 1210 to be transmitted to the light-emitting portion 1220. As a result, the light-receiving portion 1210, the light-emitting portion 1220, and the light-transfer portion 1230 may be integrally formed with one another, thereby reducing the number of components and simplifying the assembly process compared to the case in which the light-receiving portion 1210, the light-emitting portion 1220, and the light-transfer portion 1230 are individually manufactured and assembled with one another.

The light-transfer portion 1230 may include a shield portion 1231 having a front end disposed at or near the first focus F1 and a reflective portion 1232. The reflective portion 1232 may constitute a portion of an upper surface of the light guide 1220 and may reflect a portion of the light incident thereon from the light-receiving portion 1210 so as to be focused on the first focus F1.

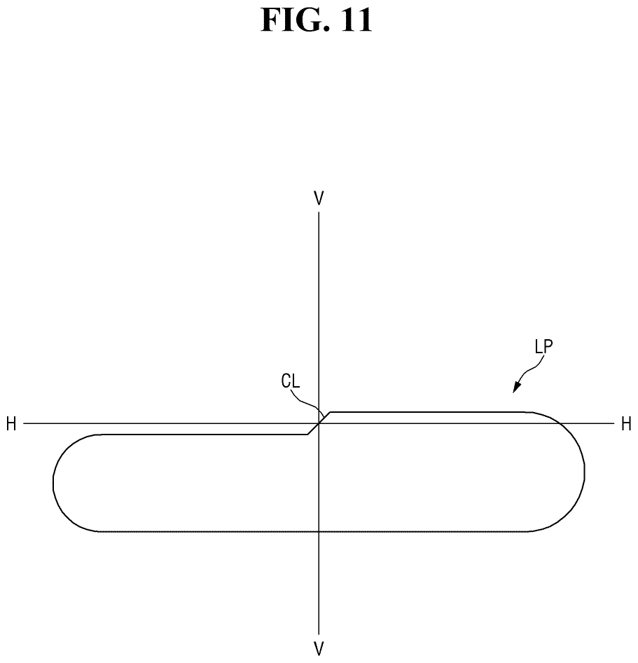

The shield portion 1231 may serve to form a low beam pattern LP obtained by the light being irradiated on a lower side under the cut-off line CL, as shown in FIG. 11.

The front end of the shield portion 1231 may be disposed at or near the first focus F1 such that the light is prevented from passing through the lower side under the first focus F1 and traveling to the light-emitting portion 1220. In this regard, the light focused on the first focus F1 and traveling to the light-emitting portion 1220 may be emitted substantially parallel to the optical axis Ax of the light source portion 1100, whereas the light that passes through the lower side under the first focus F1 and travels to the light-emitting portion 1220 may be refracted relatively upwardly and then emitted, and thus the light may be irradiated to the upper side above the cut-off line CL, potentially causing glare toward the driver of the front vehicle.

The reflective portion 1232 may serve to reflect the light incident thereto from the second light-receiving module 1212 so as to be focused on the first focus F1. The light incident on the second light-receiving module 1212 may proceed toward the second focus F2, which is formed at a position that is in a mirror image of the first focus F1 with respect to the reflective portion 1232.

In an embodiment of the present disclosure, the light that is incident on the second light-receiving module 1212 and proceeds toward the second focus F2 may be reflected by the reflective portion 1232 so as to be concentrated on the first focus F1. This is because if the light incident on the second light-receiving module 1212 were directly concentrated on the first focus F1, the light would be interfered with the shield portion 1231, resulting in light loss.

That is, the curvature, the forming angle, or the like of the area disposed above the reference line S of each of the central surface 1210a, the protruding surface 1210b, and the reflective surface 1210c may be adjusted such that the light incident on the first light-receiving module 1211 is not interfered with the shield portion 1231 even though the light is focused on the first focus F1. By contrast, the light incident on the second light-receiving module 1212 might be interfered with the shield portion 1210a, even if the curvature, the forming angle, or the like of the area disposed below the reference line S of each of the central surface 1210b, the protruding surface 1210c, and the reflective surface 1210c were to be adjusted. In this case, the light loss may occur. For this reason, the light incident on the second light-receiving module 1212 may be configured to proceed toward the second focus F2, which is disposed symmetrical to the first focus F1 with respect to the reflective portion 1232, thereby preventing the light incident on the second light-receiving module 1212 from being interfered with the shield portion 1231.

In this regard, the second focus F2 may be formed at a position symmetrical (e.g., mirror image) to the first focus F1 with respect to the reflective portion 1232. In this case, the second focus F2 may be disposed outside the upper side of the light guide 1200.

The second focus F2 may be disposed within a half height of the light light-emitting portion 1220 above the reflective portion 1232 and within a half width of the light light-emitting portion 1220. This allows the light reflected from the reflective portion 1232 to be focused on the first focus F1.

On the other hand, considering that the light-emitting surface of at least one light source included in the light source 1100 has an area of a predetermined size, a portion of the light incident on the first light-receiving module 1211 and a portion of the light incident on the second light-receiving module 1212 and reflected from the reflective portion 1232 may reach a point disposed behind the first focus F1, and the shield portion 1231 may reflect the light reaching the point disposed behind the first focus F1 so as to cause it to proceed upwardly and to the light-emitting portion 1220, thereby reducing light loss and improving light efficiency.

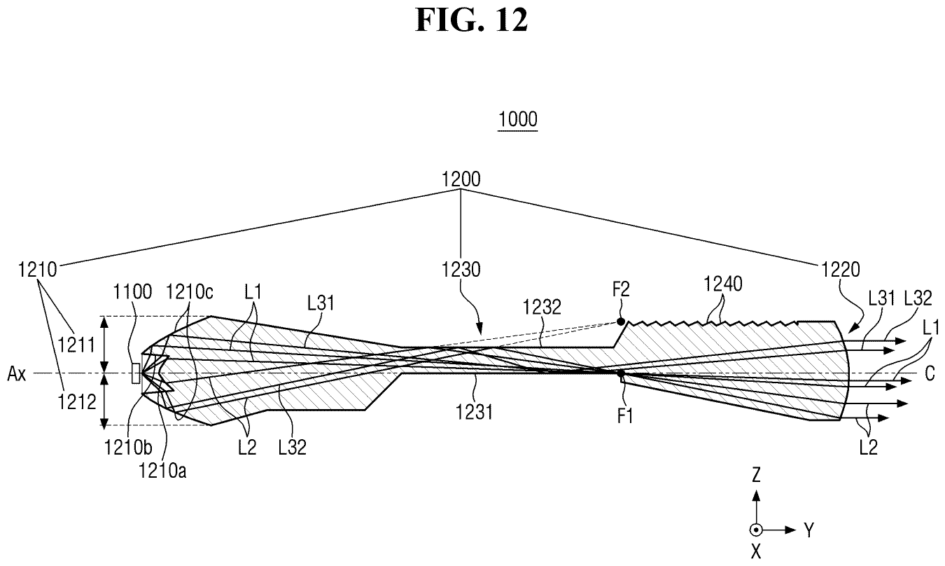

FIG. 12 is a schematic diagram showing a light path of a lamp module according to an embodiment of the present disclosure. Referring to FIG. 12, in the lamp module 1000 according to the embodiment of the present disclosure, light L1 from the light source 1100 incident to the first light-receiving module 1211 may be focused on the first focus F1 and emitted through the light-emitting portion 1220, so that the low beam pattern LP of FIG. 11 as described above may be formed.

In addition, light L2 from the light source 1100 incident to the second light-receiving module 1212 may proceed toward the second focus F2 and then be reflected by the reflective portion 1232 so as to be focused on the first focus F1 and then emitted through the light-emitting portion 1220.

In this regard, a portion L31 of the light incident on the first light-receiving module 1211 and a portion L32 of the light incident on the second light-receiving module 1212 may reach a point behind the first focus F1, and the light beams L31 and L32 reaching the point behind the first focus F1 may be reflected by the shield portion 1231 so as to proceed upwardly and emitted through the light-emitting portion 1220.

In FIG. 12, broken lines between the reflective portion 1232 and the second focus F2 represents a hypothetical light path, in case the light L2 incident on the second light-receiving module 1212 reaches the second focus F2 without being reflected by the reflective portion 1232.

As described above, the light incident on the first light-receiving module 1211 and the second light-receiving module 1212 may be emitted through the light-emitting portion 1220 without loss to form the low beam pattern LP. Thus, the number of light sources and/or the power consumption required to satisfy the required amount of light may be reduced.

In an embodiment of the present disclosure, the second light-receiving module 1212 may have a smaller curvature R22 than the curvature R12 of the first light-receiving module 1211 in the left-right direction so that the light distribution characteristic is satisfied when the light incident on the second light-receiving module 1212 is emitted through the light-emitting portion 1220 to form a beam pattern.

The light reflected from the reflective portion 1232 so as to be focused on the first focus F1 may be irradiated to a relatively lower vertical level than the vertical level to which the light incident and emitted to the first light-receiving module 1211 is irradiated. In this case, the low beam pattern LP formed by the lamp 1 for a vehicle of the present disclosure may not satisfy the light distribution characteristics.

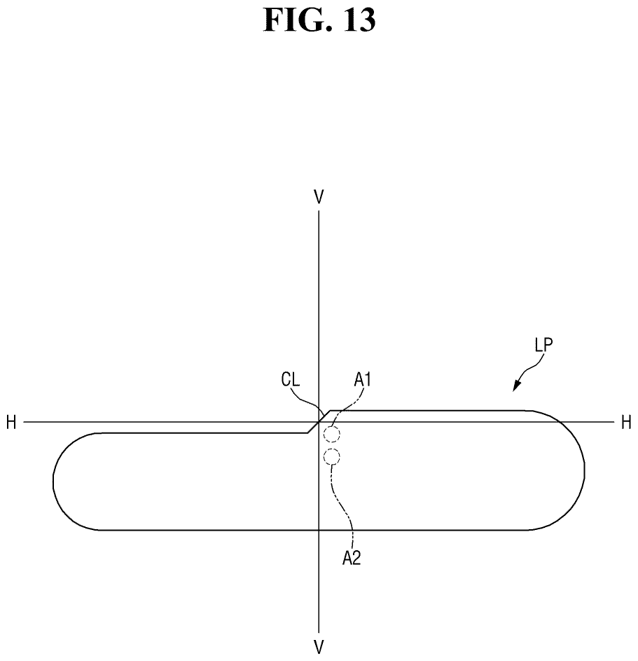

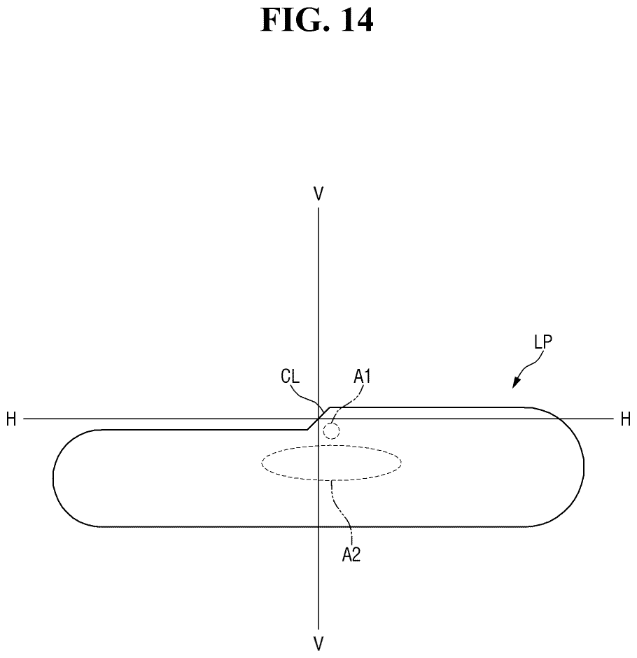

In other words, as shown in FIG. 13, the low beam pattern LP is required to have the highest brightness in a first area A1 disposed under a center of the cut-off line CL. However, the light reflected from the reflective portion 1232 allows for a second area A2 having a higher brightness than the light distribution characteristic required in an area under the first area A1 to be formed separately from the first area A1, in which case the light distribution characteristic may not be satisfied. For this reason, in an embodiment of the present disclosure, the second light-receiving module 1212 may have a smaller curvature than that of the first light-receiving module 1211 in the left-right direction, such that the light emitted through the light-emitting portion 1220 may be spread more, so that the second area A2 may be extended as shown in FIG. 14 and the brightness of the second area A2 may be relatively decreased. Accordingly, the light distribution characteristics may be satisfied.

Assuming that the amount of light reflected from the reflective portion 1232 and emitted through the light-emitting portion 1220 is constant, if the size of the second area A2 formed by the light reflected from the reflective portion 1232 and emitted through the light-emitting portion 1220 increases, the brightness thereof is relatively decreased, and thus the light distribution characteristics may be satisfied.

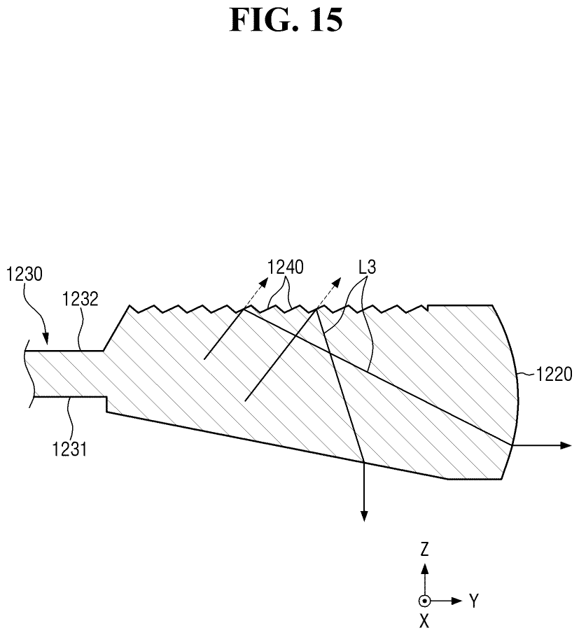

As shown in FIG. 15, an optical pattern 1240 may be formed between the reflective portion 1232 and the light-emitting portion 1220 so as to prevent the light incident on the light-receiving portion 1210 from traveling through the upper surface. Broken lines in FIG. 15 indicate paths of light if the optical pattern 1240 were not formed.

The optical pattern 1240 may serve to reflect the light L3 that proceeds toward the area of the upper surface of the light guide 1200 disposed between the reflective portion 1232 and the light-emitting portion 1220 so as to be prevent it from passing through the upper surface of the light guide 1200. The light L3 reflected from the optical pattern 1240 may be emitted through the light-emitting portion 1220 or may travel through a lower surface of the light guide 1200. The light L3 reflected from the optical pattern 1240 may improve uniformity of an image formed by the light emitted from the vehicle lamp 1 of the present disclosure when the vehicle lamp 1 of the present disclosure is viewed from the outside of the vehicle.

In general, when the vehicle lamp 1 of the present disclosure is viewed from the outside of the vehicle, the viewpoint is typically positioned above the vehicle lamp 1 of the present disclosure. Thus, when the vehicle lamp 1 is viewed from the outside of the vehicle, the light-emitting portion 1220 may be visible and the lower surface of the light guide 1200 may be visible through the light-emitting portion 1220. Thus, when the light L3 reflected from the optical pattern 1240 passes through the lower surface of the light guide 1200, not only the light emitted through the light-emitting portion 1220 but also the light passing through the lower surface of the light guide 1200 may be visible, thereby improving image uniformity.

In addition, as the optical pattern 1240 prevents the light incident on the light-receiving portion 1210 from passing through a portion of the upper surface thereof between the reflective portion 1232 and the light-emitting portion 1220, the optical pattern 1240 may not only prevent glare when the vehicle lamp 1 of the present disclosure is viewed from the outside of the vehicle, due to the position of the viewpoint from which the vehicle lamp 1 of the present disclosure is observed from the outside thereof, but also prevent the light from being irradiate to the area above the cut-off line CL, thereby preventing glare toward the driver of the front vehicle.

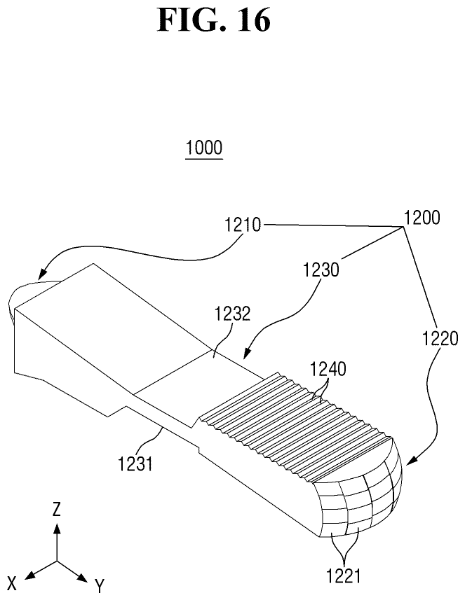

FIG. 16 is a perspective view illustrating a lamp module according to another embodiment of the present disclosure. Referring to FIG. 16, a lamp module 1000 according to another embodiment of the present disclosure may include the light source 1100 and the light guide 1200 in a similar manner to the above-described embodiment, and the components that perform the same roles as those of the above-described embodiment of the present disclosure will be denoted using the same reference numerals, and detailed descriptions thereof will be omitted.

In another embodiment of the present disclosure, the light-emitting portion 1220 may include a plurality of facets 1221. One of the plurality of facets 1221 may be formed to have at least one of a formation angle, a size, or a curvature different from the formation angle, the size, or the curvature of at least another of the plurality of facets 1221, thereby enabling a path of light to be controlled so that a beam pattern formed by the lamp 1 for a vehicle of the present disclosure may more easily satisfy the required light distribution characteristics.

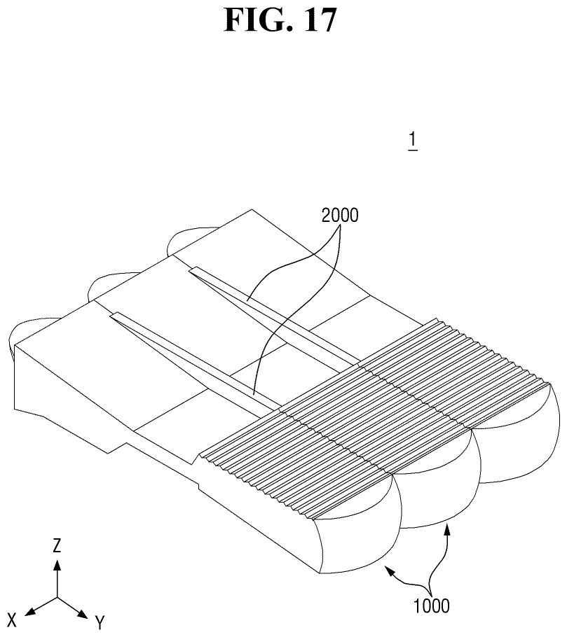

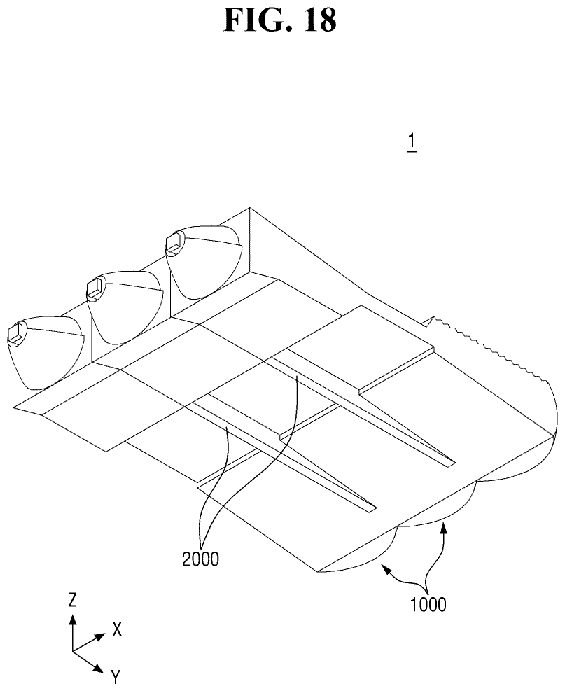

FIGS. 17 and 18 are perspective views illustrating a lamp for a vehicle according to another embodiment of the present disclosure. Referring to FIGS. 17 and 18, a lamp 1 for a vehicle according to another embodiment of the present disclosure may include the plurality of lamp modules 1000 arranged in the left-right direction as in the above-described embodiment. A reinforcing portion 2000 for enhancing rigidity may be formed in at least one of the upper surface or the lower surface thereof. The reinforcing portion 2000 may serve to reinforce the structural rigidity to prevent damage caused due to a relatively smaller thicknesses of each of the shield portion 1231 and the reflective portion 1232.

In another embodiment of the present disclosure, a case in which the reinforcement portion 2000 is formed when the vehicle lamp 1 includes the plurality of lamp modules 1000 is described by way of example. However, the present disclosure is not limited thereto, and the reinforcement portion 2000 may be formed even when the vehicle lamp 1 of the present disclosure includes a single lamp module.

As described above, in the lamp 1 for a vehicle according to the present disclosure, when the low beam pattern LP is formed by the light being irradiated to the lower side under the cut-off line CL, the light may proceed and be emitted through the light-emitting portion 1220 without loss due to being blocked by interference with the shield portion 1231. Thus, the light loss may be reduced.

Those of ordinary skill in the art to which the present disclosure pertains will understand that the present disclosure may be practiced in other specific forms without changing its technical idea or essential features. Therefore, it should be understood that the embodiments described above are not restrictive but illustrative in all aspects. The scope of the present disclosure is indicated by the scope of the claims to be described later rather than the above detailed description, and it should be interpreted that all changes or modified forms derived from the meaning and the scope of the claims and the equivalent thereto are included in the scope of the present disclosure.

What is claimed is:

1. A lamp for a vehicle including at least one lamp module forming a beam pattern, wherein the at least one lamp module includes:
a light source that generates light; and
a light guide that guides the light incident thereon from the light source to be emitted,
wherein the light guide includes:
a light-receiving portion that receives the light from the light source;
a light-emitting portion through which the light incident thereon from the light-receiving portion is emitted; and
a light-transfer portion that is connected to and disposed between the light-receiving portion and the light-emitting portion and transmits at least a portion of the light incident from the light-receiving portion to the light-emitting portion, and
wherein the light-receiving portion has upper and lower portions formed asymmetrically with each other with respect to a reference line that coincides with an optical axis of the light source.

2. The lamp for the vehicle of claim 1, wherein the light-receiving portion includes:
a central surface having a central point disposed on the optical axis of the light source;
a protruding surface formed to protrude from an edge of the central surface toward the light source; and
a reflective surface that reflects the light incident on the protruding surface so as to cause it to proceed in a forward direction,
wherein upper and lower regions of at least one of the center surface, the protruding surface, or the reflective surface are formed asymmetrically with each other with respect to the reference line.

3. The lamp for the vehicle of claim 1, wherein the light-receiving portion includes:
a first light-receiving module that is disposed above the reference line and focuses the light incident thereon from the light source on a first focus; and
a second light-receiving module that is disposed below the reference line and causes the light incident thereon from the light source to proceed toward a second focus.

4. The lamp for the vehicle of claim 3, wherein the first focus corresponds to a rear focus of the light-emitting portion.

5. The lamp for the vehicle of claim 3, wherein the second focus is disposed above the first focus.

6. The lamp for the vehicle of claim 3, wherein the first focus is formed inside the light guide, and
wherein the second focus is formed above an upper side of the light guide.

7. The lamp for the vehicle of claim 3, wherein the first light-receiving module and the second light-receiving module have different curvatures in at least one of a vertical direction or a left-right direction.

8. The lamp for the vehicle of claim 7, wherein a vertical curvature of the first light-receiving module is smaller than a vertical curvature of the second light-receiving module, and
wherein a lateral curvature of the first light-receiving module is greater than a lateral curvature of the second light-receiving module.

9. The lamp for the vehicle of claim 3, wherein the first light-receiving module and the second light-receiving module have different dimensions in at least one of a vertical direction or a left-right direction.

10. The lamp for the vehicle of claim 9, wherein a vertical height of the first light-receiving module is greater than a vertical height of the second light-receiving module, and
wherein a lateral width of the first light-receiving module is smaller than a lateral width of the second light-receiving module.

11. The lamp for the vehicle of claim 1, wherein the light-transfer portion includes:
a shield portion constituting a portion of a lower surface of the light guide, the shield portion having a front end disposed at or near a first focus, which corresponds to a rear focus of the light-emitting portion; and
a reflective portion that constitutes a portion of an upper surface of the light guide and reflects a portion of the light incident thereon from the light-receiving portion so as to cause it to be focused on the first focus.

12. The lamp for the vehicle of claim 11, wherein the reflective portion reflects the light incident through a lower portion of the light-receiving portion and proceeding toward a second focus, which is disposed above the first focus, so as to cause it to be focused onto the first focus.

13. The lamp for the vehicle of claim 12, wherein the second focus and the first focus are mirror images with each other with respect to the reflective portion.

14. The lamp for the vehicle of claim 11, wherein the light guide includes an optical pattern formed between the reflective portion and the emitting portion, and
wherein the optical pattern prevents the light incident onto the light-receiving portion from transmitting through an area between the reflection portion and the light-emitting portion and proceeding upwardly of the light guide to exterior.

15. The lamp for the vehicle of claim 1, wherein the light-emitting portion has a convex or concave shape in a forward direction.

16. The lamp for the vehicle of claim 1, wherein the light-emitting portion includes a plurality of facets, and
wherein at least one of a formation angle, a curvature, or a size of one of the plurality of facets is different from the formation angle, the curvature, or the size of at least another of the plurality of facets.

17. The lamp for the vehicle of claim 1, wherein the light guide includes a reinforcement portion formed in at least one of an upper surface or a lower surface of the light guide to reinforce structural rigidity.
